(19) United States
(12) Patent Application Publication
(10) Pub. No.: US 2017/0171736 A1
(43) Pub. Date: Jun. 15, 2017

(54) DYNAMIC PRICING FOR USE OF NETWORK

(71) Applicant: Lenovo (Singapore) Pte. Ltd., New Tech Park (SG)

(72) Inventors: Arnold S. Weksler, Raleigh, NC (US); Rod D. Waltermann, Rougemont, NC (US); John Carl Mese, Cary, NC (US); Nathan J. Peterson, Oxford, NC (US); Russell Speight VanBlon, Raleigh, NC (US)

(21) Appl. No.: 14/963,542

(22) Filed: Dec. 9, 2015

(51) Int. Cl. H04W 4/24; H04M 15/00

(52) U.S. Cl. CPC H04W 4/24; H04M 15/61; H04M 15/723

(57) ABSTRACT

In one aspect, a first device includes a processor, a display accessible to the processor, and storage accessible to the processor. The storage bears instructions executable by the processor to receive data from a second device different from the first device comprising a price for usage of a first network, and to present at least a first option on the display. The first option indicates the price for usage of the first network and is selectable to enable the first device to communicate using subscriber identification module (SIM) data with a third device over the first network. The instructions are also executable to, in response to selection of the first option, enable the first device to communicate using the SIM data with at least the third device over the first network.

### FIELD

The present application relate generally to pricing for use of a network.

### BACKGROUND

As recognized herein, in many places around the globe, users wishing to communicate using a cellular network can only access one such network using their device, and cannot access another cellular network without physically removing one subscriber identification module (SIM)—often called a “SIM card”—from fee device that is usable with the first network and replacing it with another SIM for use with the other cellular network. This can he burdensome, laborious, and confusing, to say the least.

Furthermore, even when a user does so, the user is still typically required to enter into relatively long term and costly contracts with the operators of these cellular networks in order to communicate over the networks using the different SIMs. Users thus opt to, more often than not, commit to but one contract and communicate over but one cellular network using their device. However, communicating over a single cellular network can be frustrating at times too, such as when the cellular network does not have ample available bandwidth to support the user's needs.

### SUMMARY

Accordingly, in one aspect a first device includes a processor, a display accessible to the processor, and storage accessible to the processor. The storage bears instructions executable by the processor to receive data from at least a second device different from the first device comprising a price for usage of a first network. The instructions are also executable to present at least a first option on the display. The first option indicates the price for usage of the first network and is selectable to enable the first device to communicate at least in part using subscriber identification module (SIM) data with at least a third device over the first network. The instructions are also executable to, in response to selection of the first option, enable the first device to communicate at least in part using the SIM data with at least the third device over the first network.

In another aspect, a method includes accessing data pertaining to a first price for using a first network and a second price for using a second network different from the first network. The method also includes receiving user input to join the first network and joining the first network using subscriber identification module (SIM) data.

In still another aspect, a method includes operating a cellular network and providing a pricing parameter to a device. The pricing parameter pertains to use of the cellular network during a particular period of time in a particular day.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIGS. 3 and 9 are flow charts showing example algorithms in accordance with present principles;

FIGS. 4-8 and 11 are example user interfaces (UI) in accordance with present principles; and

FIG. 10 is an example data table in accordance with present principles.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet a local intranet, or a virtual private network.

As used herein, instructions refer to computer-implemented steps for processing information in the system. Instructions can be implemented in software, firmware or hardware; hence, Illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated, circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can he redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that may not be a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless, communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between, the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may he combined, interchanged or excluded from other embodiments,

“A system, having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C” ) includes systems that have A alone, B alone, C atone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from-discrete logic circuits to the highest level of circuit integration such as VLSI, and includes programmable logic components programmed to perform the functions of an embodiment as well as general-purpose or special-purpose processors programmed with instructions to perform those functions.

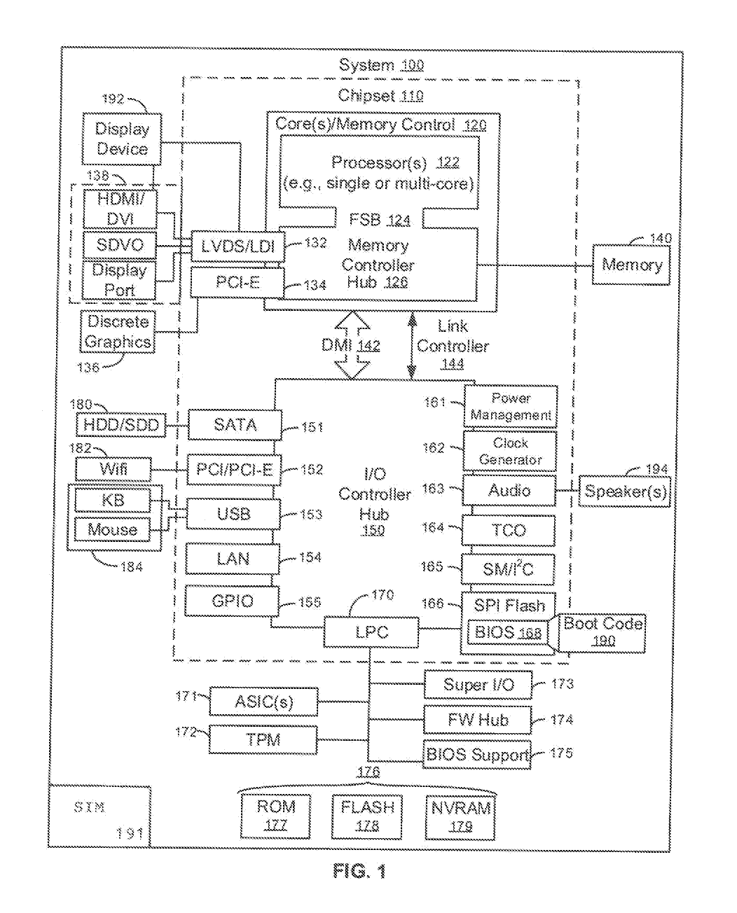

Now specifically in reference to FIG. 1, an example block diagram of an information handling system and/or computer system 100 is shown. Note that in some embodiments, the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX® or Playstation®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interlace (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single care or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS Interlace 132 (e.g., serial digital video, HDMI/DVI, display port). The memory controller hub 126 also includes one or more PCI-express interfaces (PCI-E) 134, for example, for support of discrete graphics 136. Discrete graphics using s PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interlaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof but in any ease the drives 180 are understood to be, e.g., tangible computer readable storage mediums that may not be transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may he used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may he stored in airy of a variety of locations and accessed, for example, according to instructions of the BIOS 168.

The system 100 also includes a subscriber identification module (SIM) 191. The SIM 191 is understood to be usable in accordance with present principles, such as to store plural sets of “virtual” SIM data that is used by the system 100 to respectively communicate over different (e.g., at least partially wireless) cellular networks, such as using various sets of international mobile subscriber identity (IMSI) numbers and authentication keys.

Additionally, though now shown for clarity, in some embodiments the system 100 may include a gyroscope that senses and/or measures the orientation of the system 100 and provides input related thereto to the processor 122, as accelerometer that senses acceleration and/or movement of the system 100 and provides-input related thereto to the processor 122, an audio receiver/microphone that provides input to the processor 122 based on, e.g., a user providing audible input to the microphone, and a camera that gathers one or more images and provides input related thereto to the processor 122. The camera may he a thermal imaging camera, a digital camera such as a webcam, a three-dimensional (3D) camera, and/or a camera otherwise integrated into the system 100 and controllable by the processor 122 to gather pictures/images and/or video. Still further, and also not shown for clarity, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to fee understood at least based on the foregoing that the system 100 is configured to undertake present principles.

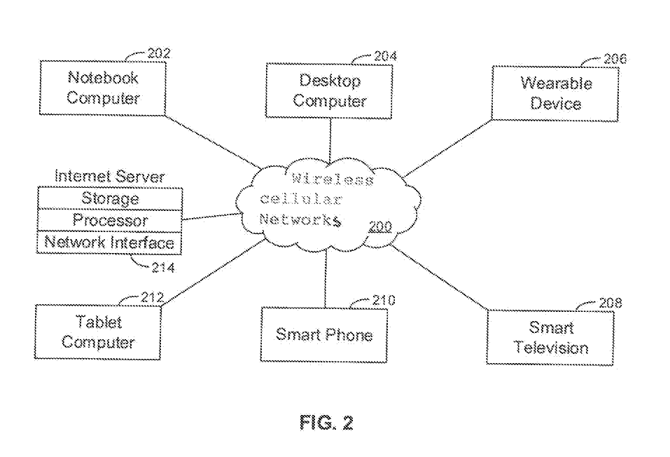

Turning now to FIG. 2, example devices are shown communicating over one or more cellular networks 200 through which telephone calls may be placed, and the Internet accessed, in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the cellular networks 200 to undertake present principles. The networks 200 themselves may be respectively operated by different operators, carriers, providers, etc., and be established by various cells, base stations, and/or communication towers having, e.g., fixed-location transceivers.

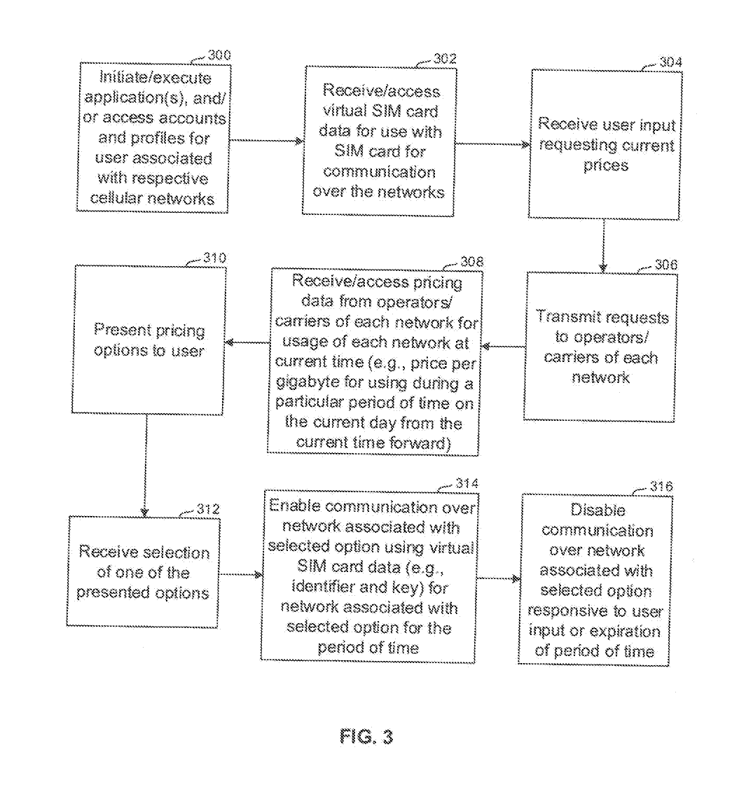

Referring to FIG. 3, it shows example logic that may he undertaken by a device such as the system 100 for viewing pricing and selecting a network over which to communicate based on currently-offered prices in accordance with present principles (referred to when describing FIG. 3 as the “present device”). Beginning at block 300, the logic initiates and/or executes one or more applications for undertaking present principles, such as an Internet application, a wireless carrier-provided application, a virtual SIM application, etc. In some embodiments and also at block 300, the logic may access one or more accounts and/or profiles for a particular user of the present device, such as accessing a user's accounts tor each of plural cellular network operators/providers. The accounts and/or profiles may be accessed using one or more of the applications launched at block 300, and may be accessed over the Internet, one of the cellular networks, etc.

From block 300 the logic may proceed to block 302. At block 302 the logic may receive, access, and/or store (e.g., in a physical SIM (such as a SIM “card”) housed in the present device) “virtual” subscriber identification module (SIM) data that is usable for the present device to identify and authenticate itself to a network it seeks to join to then communicate with other devices using the network. The virtual SIM data (for one or more cellular networks) may be stored in the SIM itself and/or at another storage location within or accessible to the present device. The virtual SIM data may comprise items such as an identification/identity number that identifies the present device, a network subscriber, and/or an account (e.g., associated with the user) for accessing the associated network, such as an international mobile subscriber identity (IMSI) number. In addition to still other information (such as temporary network information, data regarding accessible network services for the user/device, and passwords such as a personal identification number (PIN) and a personal unblocking code (PUK) usable for PIN unlocking), the virtual SIM data may also comprise an authentication key that is useable to authenticate the present device, subscriber, and/or account with the operator/carrier and/or associated network.

The virtual SIM data for each network operator/carrier may be received from each respective operator/carrier of each, network (e.g., using an Internet connection and prior to execution of the logic of FIG. 3), and/or may be already stored at the present device at the time of purchase of the present device from a manufacturer or seller of the present device. However, also note that in some embodiments, the virtual SIM data may be received, accessed, and/or stored at a later point such as at blocks 308 or 314, as will be described further below.

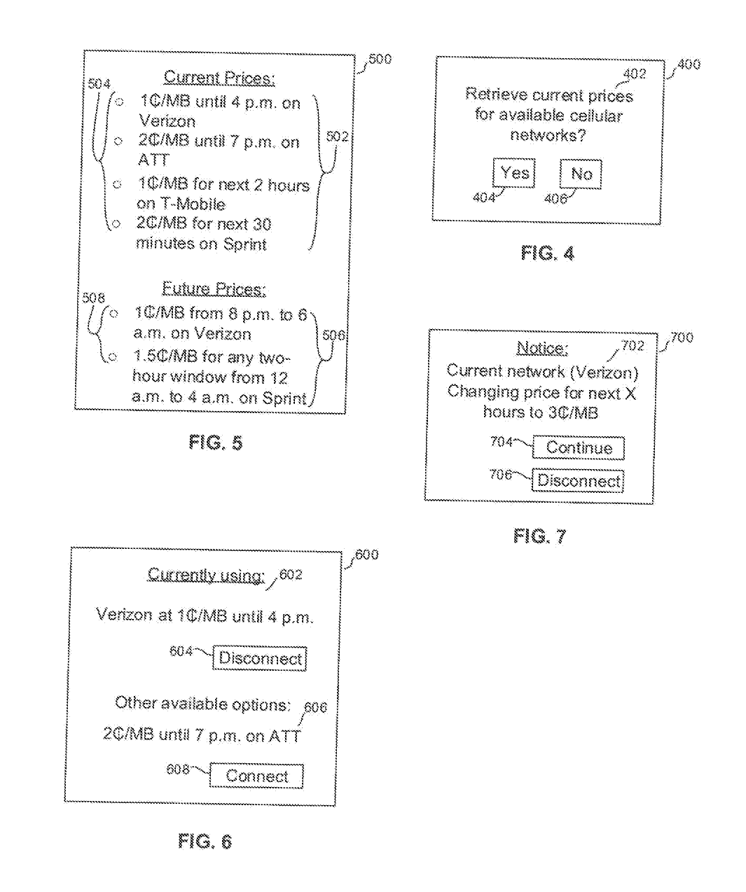

From block 302, the logic of FIG. 3 then moves to block 304. At block 304 the logic receives user input requesting currently offered prices by each network operator/carrier to use their network at the current time. The user input may be received based at least in part on touch input received to a user interface (UI) presented on a display of the present device, such as the UI 400 to be described below in reference to FIG. 4. The prices that are offered and how they are determined by the operators/carriers will be discussed further below as well. In any case, responsive to receipt of the user input at block 304, the logic moves to block 306.

At block 306 the logic transmits current pricing data requests to each network carrier/operator, and/or transmits such a request to a single entity (e.g., a coordinating server) that receives and stores current prices and associated data for each network carrier/operator (or otherwise determines them). The requests may he transmitted using the Internet or another network accessible to the present device and connected to another device, and/or to the carriers/operators themselves, from which the pricing data may be acquired. Then at block 308, based on the requests transmitted at block 306, the logic receives back and/or retrieves from each network carrier/operator, and/or from the single entity, current pricing data for use of each respective network at the current time. The data may also pertain to pricing for using each network not just at the current time, but for a length of time (e.g., from the current time) and/or for a predefined window of time (e.g., from the current time). Still further, the data may pertain to quality of service offered at the current pricing, such as a certain price being for use of 3G Internet network capabilities while another price being tor use of 4G Internet network capabilities

For example, the data may include prices per gigabyte (GB) or megabyte (MB) of 4G data used, transmitted, or received during a specified time on the current day from the current time forward, prices per minute of telephonic communication engaged, in during a specified time on the current day from the current time forward, prices per text message sent or received during a specified time on the current day from the current time forward, etc. Thus, it is to be understood that the prices that are received as part of the pricing data may vary (e.g., based on network operator/carrier preference and parameters) based on current time of day, current day of the week, current day of the month, current day of the year, etc., in addition varying in some embodiments (e.g., as determined by each network carrier/operator) based on overall current network usage and/or resources consumed on each respective network (e.g., usage not just by the present device hut by other and/or all devices currently communicating over the network). Further still, it is to be understood that in some embodiments, the pricing data may include data for prices effective during future time ranges and/or lengths of time, so that a user may be made aware of prices for use of the networks that are effective and/or valid at future times.

Moreover, though not shown on the face of FIG. 3, it is to he understood that in some embodiments, such as based on user preference and/or network operator/carrier preference, virtual SIM data for using the respective network may be received with the pricing data at block 308 (e.g., if this data was not received at another point or if it is to be updated).

Still in reference to FIG. 3, from block 308 and responsive to receiving the pricing data at block 308 the logic moves to block 310, where the logic presents one or more pricing options on the present device that were identified and/or derived from the pricing data received at block 308. For example, the pricing options may be presented as part of a UI presented on a display accessible to the present device, such as the UI 500 to be discussed below, and/or presented audibly over speakers accessible to the present device.

After block 310 the logic moves to block 312, where the logic receives a user's selection of one of the pricing options presented, such as via receiving touch input directed to a UI presented at block 310. Responsive to receipt of the input at block 312, the logic then moves to block 314 where the logic enables communication over a network associated with the selected option and/or the network to which the price of the selected option pertains. The present device may enable communication over the selected network by using the present device's SIM or another storage area (e.g., if the present device does not have a physical SIM) to access and identify virtual SIM data stored therein for use of the selected network and transmitting this virtual SIM data, using a network transceiver (e.g., wireless telephony transceiver), to a device associated with the network carrier/operator (e.g., a cell tower, a base station, a server, etc.) to identify (e.g., using a SIM identity number) and authenticate (e.g., using a SIM key) the present device to thus gain access to the network associated with the selected option to communicate with other devices over the network.

Communication may be enabled at block 314 at least for the length of time, and/or during the time range, associated with the price of the selected option (e.g., as determined based data pertaining to the length of time and/or time range received at block 308). In addition to or in lieu of the foregoing, communication may also be enabled at block 314 as long as the price associated with the selected option remains effective and/or valid even if beyond the length of time and/or time range, and/or as long as the user chooses to maintain access to the network associated with the selected option for communication (e.g., as determined based on user input to the present device). Still further, communication may be enabled m some embodiments until the carrier/operator unilaterally ends the availability of usage of the network at the selected price even if ending before the length of time concludes and/or end of the time range is reached, and then may be automatically disabled responsive to the carrier/operator ending the availability, such as may occur if current demand for the network goes up. In this way the user may avoid unintentionally accruing excess charges for use for use of the network at prices higher than the selected price.

On that but more generally, note that charges accrued for using the network at the selected price may be assessed by the carrier/operator to an account and/or profile of the user identifiable based on the virtual SIM data used to access the network, such as one of the accounts and/or profiles initially accessed at block 300. The user may then pay as they go (e.g., prepay for an estimated amount he or she will use the network at the current price) and/or pay for accrued charges at a later time, such as on a monthly basis.

Before moving on to the description of block 316, it is to be understood that in some embodiments at block 314, such as based on user preference and/or network operator/carrier preference, the logic may receive, from the carrier/operator of the selected network, virtual SIM data for using the selected network responsive to receipt of the selection at block 312 and transmission of a request for the virtual SIM data (e.g., if this data was not received at another point or if it is to be updated)

Now in reference to block 316, after enabling communication at block 314 the logic may disable communication over the network associated with the selected option at block 316. Communication may be disabled at block 316 responsive to identification of conclusion of the length of time at which the selected price is valid, responsive to identification of reaching the end of the time range at which the selected price is valid, responsive to identification of the selected price no longer being valid (e.g., even if the carrier/operator makes it valid for longer than the length of time and/or time range or if the carrier/operator ends the price offering early), and/or responsive to receipt of user input to disable communication over the network. Communication may be disabled at block 316 by ending the connection and/or ceasing to maintain the connection at the present device's cellular the transceiver being used to maintain the network connection, such as by deactivating the transceiver or ceasing to transmit data that is used in some embodiments to maintain the connection (e.g., so-called “keep-alive” packets).

Continuing the detailed description in reference to FIG. 4, it shows an example user interface (UI) 400 presentable on a display of the system 100 and/or a device undertaking the logic the FIG. 3. The UI 400 includes a prompt 402 asking whether a user wishes to retrieve current prices for use of available networks (e.g., networks for which signal strength for communication is existent or above a threshold, or that are otherwise currently available for use by the device for communication). Thus, a yes selector 404 is shown, that is selectable to automatically without further user input retrieve such prices in accordance with present principles, while a no selector element 406 is al so shown that is selectable to automatically without further user input decline to do so. Note that the UI 400 may be presented, for example, responsive to initiation. invocation, and/or execution of an application such as one of the ones launchable at block 300 as described above, responsive to accessing a network profile or network account associated with the user, responsive to a user request to present it (e.g., voice input), etc.

In any case, responsive to selection of the selector 404 and/or based on other user input, current prices may be retrieved and a UI 500 as shown in FIG. 5 may be presented that lists currently available prices for use of various networks at the current time (e.g., the time at which, or at least proximate to the time at which, the UI 500 is presented). The UI 500 lists one or more options 502 respectively indicating prices for use of a respective network at that time (and in some embodiments, respectively indicating prices for different types of use, such as telephonic communication, text message communication, and data usage). The options 502 are also respectively selectable using the respective radio buttons 504 shown, next to each option 502 to select that respective option, and hence the price and network associated with that option. As may be appreciated from FIG. 5, the example options shown include prices per megabyte for data usage during certain times from the current time forward on the networks operated respectively by Verizon, AT&T, T-Mobile, and Sprint. Additionally, though not shown for clarity, it is to he understood that each option 502 may indicate a quality of service (e.g., data rates) associated with the price, such as the price being per megabyte of data downloaded using 3G Internet networking technology while another price being per megabyte of data downloaded using 4G Internet networking technology.

Even further, m some embodiments the UI 500 may include options 506 respectively indicating prices for use of respective networks at future times (and in some embodiments, respectively indicating prices for different types of use at future times). The options 506 are respectively selectable using the respective radio buttons 508 shown next to each option 506 to select that respective option, and hence the price and network associated with that option for use at the future time/range specified on the UI 500.

Continuing now in reference to FIG. 6. another example UI 600 is shown. The UI 600 in ay be presented, e.g., responsive to selection of an option from the UI 500 and/or enablement of communication over a given cellular network using, virtual SIM data in accordance with present principles. The UI 600 includes an indication 602 of a network currently being used to communicate, the name of the network and/or name of the operator/provider of the network, the price for communication during the current time, and/or a time frame and/or length of time during which the current price is valid. The indication 602 may be accompanied by a selector 604 selectable to automatically without farther user input disconnect from the currently used network and/or otherwise disable communication using it.

Furthermore, in some example embodiments the UI 600 may also list one or more other currently available options 606 indicating respective other currently available prices for use of other respective currently available networks at the current time. This list of other currently available options may automatically and dynamically update, e.g., in real time (or at least substantially in real time owing to data processing and resource constraints) as prices and available networks change and/or become available over time. Thus, it is to be understood that even though connected to one cellular network for communication, other prices may be periodically determined and/or continually determined by the device (e.g., as a background process), such as via the connected-to cellular network or through another network connection such as a Wi-Fi connection. In any case, each respective other currently available network option 606 may be respectively accompanied by a connect selector 608 selectable to automatically without further user input disconnect and/or disable communication over the currently connected-to cellular network and connect to and/or enable communication with the network associated with the selected option 606 at the price indicated and using virtual SIM data in accordance with present principles.

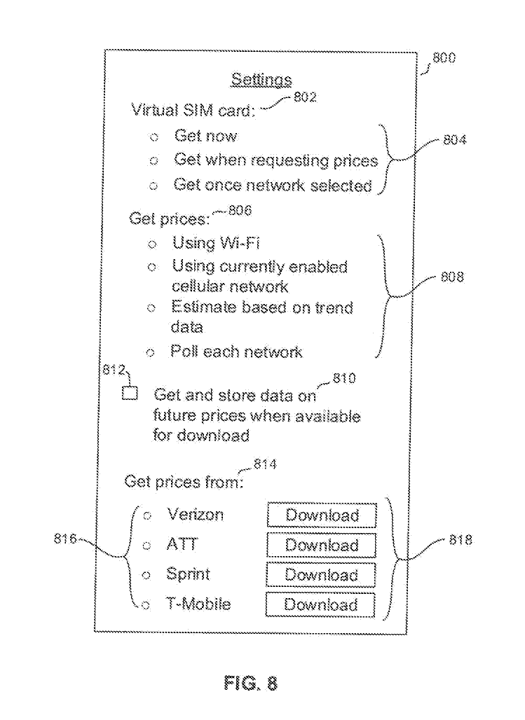

Moving on. FIG. 7 will now be described. FIG. 7 shows an example UI 700 presenting a notice 702 that a price for using a currently connected-to cellular network is about to change, indicating the currently connected-to network, and indicating the net price change amount or new price along with the time frame during which the new price is effective. A continue selector 704 is thus presented on the UI 700 that is selectable to automatically without further user input continue to maintain the connection to the currently connected-to network and communicate over it at the new price. A disconnect selector 706 is also shown that is selectable to automatically without further user input disconnect from the currently connected-to network either immediately (e.g., responsive to selection of the element 706) or at time at which the current price expires and the new price takes effect. Furthermore, note that though not shown for clarity, options for other currently available networks and prices may also be presented on the UI 700, such as those similar to the option(s) 606 described above. Before moving on to the description of FIG. 8, it is to also he understood in reference to FIG. 7 that the UI 700 may be presented, in some embodiments, at a threshold time from when the price change is identified to occur and/or at which the new price takes effect.

Continuing now in reference to FIG. 8, it shows ail example settings UI 800 presentable on a display of the system 100 and/or a device undertaking the logic the FIG. 3. The UI 800 includes a first setting 802 related to acquisition of virtual SIM data from one or more network operators/carriers and listing options 804 respectively selectable using the radio buttons shown next to each option to acquire the virtual SIM data responsive to selection of the first option shown for setting 802, to acquire the virtual SIM data when requesting current, prices for using respective cellular networks, and to acquire the virtual SIM data once a network and currently available price has been selected.

The UI 800 also includes a setting 806 related to how/when the device is to acquire currently available prices for use of various cellular networks and listing options 808 respectively selectable using the radio buttons shown next to each option to acquire currently available prices using a Wi-Fi connection, using a currently connected-to cellular network, using general trend data available to the present device to then estimate or extrapolate a currently available price based on past prices, past network activity, and/or past times of day, and using each respective network to poll each cellular network carrier/operator for current prices prior to joining the network to communicate with other (e.g., end-user) devices.

Still in reference to FIG. 8, the UI 800 may also include an option 810 enableable using check box 812 to acquire and store (when they are available for download) data on future prices for use of various cellular networks at future times (e.g., available for download with prices for current use) so that they may be presented on the device and selected by the user when the future time(s) become current.

The UI 800 may also include a setting 814 for selecting one or more networks using respective radio buttons 816 from which current prices for using the respective networks are to be acquired, and communication enabled. The setting 814 also includes respective download selectors 818 next to each cellular network option that are selectable to one or both of automatically without further user input download/acquire a currently available price(s) for use of the respective network or automatically without further user input download/acquire virtual SIM data for use of the respective network.

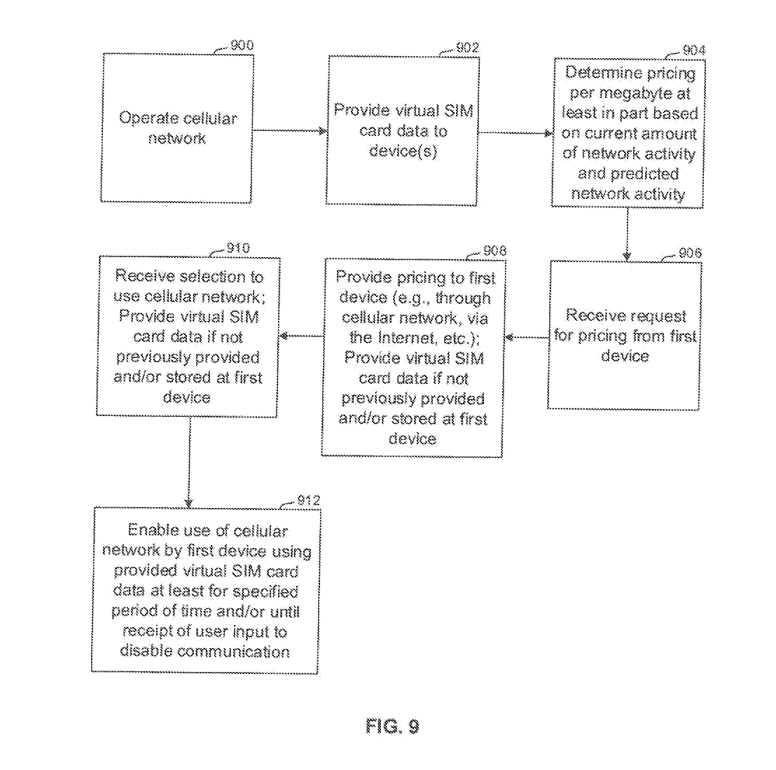

Reference is now made to FIG. 9, which shows example logic that may be undertaken by a device of a cellular network carrier/operator, such as a cell tower computer, base station computer, carrier/operator server, carrier/operator control device, etc. Beginning at block 900, the logic operates a cellular network, such as by enabling devices to communicate with each other using, the network and/or making its network available for such communication. The logic then moves to block 902 where the logic provides virtual SIM data useful for accessing its network to one or more other devices, such as a user's smart phone.

After block 902 the logic then proceeds to block 904 where the logic determines a price per byte, per increment of time of telephonic communication, and/or per text message sent and/or received. The logic may do so at block 904 based on input specified by and received from an administrator of the cellular network, based on data in a data table correlating amounts of traffic and/or times of day with prices for use during those times, based on a current amount of network activity on the cellular network and/or a current amount of network resources being consumed so that the price is correlated (e.g., directly) to network demand and/or availability of network resources (and hence, for instance, prices may be cheaper when there is a surplus of network availability/bandwidth), and/or based on a predicted amount of network activity and/or network resources to he consumed over a certain (e.g., threshold) period of time or time range to occur in the future (where the predicted amount may itself be determined based on available trend data for past instances during a similar day or time of day), etc.

From block 904 the logic of FIG. 9 moves to block 906. At block 906 the logic receives a request for a current prices) tor using the cellular network from a first device, such as a device executing the logic of FIG. 3. Thus, responsive to receipt of the request at block 906, at block 908 the logic, provides one or more current prices to the first device (such as through the cellular network itself or via the internet). Also at block 908 in some embodiments, the logic may provide virtual SIM data to the first device, such as based on a received request for the data and/or if not previously provided to or stored at the first device.

Then at block 910 the logic receives a selection and/or request from the first device to use the cellular network at the currently available price(s). Also at block 910 in some embodiments, the logic may provide virtual SIM data to the first device, such as based on a received request for the data and/or if not previously provided to or stored at the first device. But in any case, from block 910 the logic then moves to block 912 where the logic enables use of the cellular network by the first device using the virtual SIM data (e.g., after identifying and authenticating the first device) and for the specified period of time for the price offered and accepted by the first device, and/or until user input is received to disable communication over the cellular network.

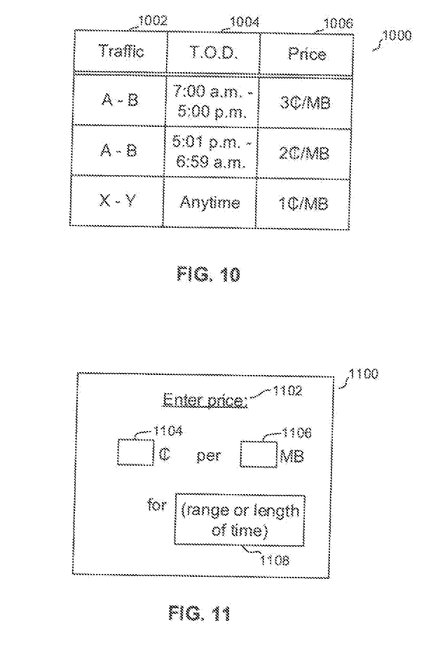

Reference is now made to FIG. 10, which shows a data table 1000 accessible to a device undertaking the logic of FIG. 9 and correlating amounts of traffic and/or times of day with prices for use during those times. The table 1000 includes a first column 1002 indicating ranges of amounts of traffic (expressed as variables in the present example for simplicity), a second column 1004 indicating times of day, and a third column 1006 indicating prices per increment for using the network during one of both of the times in which the network is experiencing traffic in an amount within a range specified in column 1002 and times of day specified in column 1004.

Accordingly, as an example, a device undertaking the logic of FIG. 9 may, at block 904, access the data table 1000. Then, based on an identified amount of network traffic, the logic may parse the entries in column 1002 until a match is made at column 1002 to the identified amount (e.g., that the identified amount falls within the range noted in the entry). The logic may then move horizontally across the data table 1000 to column 1006 to identify the price per increment to be offered for using the network while current network traffic is at the identified amount.

Moving on, FIG. 11 shows an example UI 1100 for a network administrator to enter or specify a price for using the network during a certain current time. The UI 1100 includes a prompt 1102 to enter a price at box 1104 per given increment as may be entered to box 1106. The UI 1100 also includes a box 1108 at which a range or length of time during which the price is to be offered and effective may be entered. The information entered to the UI 1100 may then be stored and used, for example, at block 904 of FIG. 9 to identify a current price for use of the network per die carrier/operator's preference.

It is to be generally understood that present principles may be applied for use in still other networks besides cellular networks, such as Wi-Fi networks. It is to also be understood that in some embodiments, end-users of the devices undertaking present principles (e.g., devices undertaking the logic of FIG. 3) may use a UI to offer to carriers/operators a price per increment they are willing to currently pay for usage of the carrier/operators cellular network, which may then be electronically submitted to the carriers/operators and the carriers/operators may then accept or decline and hence allow or disallow use of their network using virtual SIM data at the end-user offered price.

Furthermore, in some embodiments certain virtual SIM data that Is being used may be switched based on a country in which the device is located, so that virtual SIM data may be used that affords the lowest possible rate for the country in which the device is currently disposed rather than an out-of-country international rate that may otherwise be applied if different virtual SIM data were used. Also in some embodiments, a price may be offered by a carrier/operator for an all-inclusive rate regardless of different types of use so that, for example, a single rate may be offered based on time of day and/or network traffic for use of both the cellular network provider's telephony system and data system.

Still further, it is to he generally understood that although a user may select an option to enable a device to communicate based on a certain price offered by the carrier/operator, in some embodiments a device undertaking present principles may operate a background process to undertake present principles and may, once configured such as based on user preference, automatically and without further user input select the best available price so that the device continually switches to a best (e.g., lowest) price when/while available. What's more, in some embodiments virtual SIM data for two different networks and/or kinds of services may be used, so that, for example, a user may take advantage of a lowest offered price tor placing a telephone call using one carrier's network while concurrently browsing the Internet using another carrier's network that has offered a lowest price for data.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that Is being vended and/or provided, where the computer readable storage medium Is not a transitory signal and/or a signal per se.

While the particular DYNAMIC PRICING FOR USE OF NETWORK is herein shown and described in detail, it is to be understood that the subject matter which is encompassed by the present application is limited only by the claims.

1. A first device, comprising:
a processor;
a display accessible to the processor; and
storage accessible to the processor and bearing instructions executable by the processor to:
receive data from at least a second device different from the first device, the data comprising a price for usage of a first network; and
present at least a first option on the display, the first option indicating the price for usage of the first network and being selectable to enable the first device to communicate at least in part using subscriber identification module (SIM) data with at least a third device over the first network, the third device being different from the first device and the second device;
in response to selection of the first option, enable the first device to communicate at least in part using the SIM data with at least the third device over the first network;
present at least a second option on the display, the second option indicating the price for usage of a second network and being selectable to enable the first device to communicate at least in part using SIM data with at least the third device over the second network, each of the first and second options further indicating first and second prices for telephonic communication and data usage, respectively, at least one of the prices being per megabyte.

2. The first device of claim 1, wherein the instructions are executable by the processor to:
enable the first device to communicate with at least the third device over the first network at least in part using virtual SIM data.

3. (canceled)

4. The first device of claim 1, wherein at least one of the first and second options indicates a data rate associated with a respective price.

5. The first device of claim 1, wherein the SIM data is received based at least in part on selection of the first option.

6. The first device claim 1, comprising a SIM accessible to the processor, wherein the SIM data is stored in the SIM prior to receipt of the data comprising the price.

7. The first device claim 1, wherein the SIM data comprises an identity number and a key.

8. The first device of claim 1, wherein the instructions are executable by the processor to:
enable the first device to communicate with at least the third device over the first network at least in part using information from an operator of the first network.

9, 10. (canceled)

11. The first device of claim 1, wherein the SIM data for communicating with the first network is associated with a first operator of the first network, and wherein the SIM data for communicating with the second network is associated with a second operator of the second network, the first operator being different from the second operator.

12. The first device of claim 1, wherein the first option is presented as part of a user interface (UI) presented on the display.

13. The first device of claim 1, wherein the first option indicates that the price is for a particular time range that is not indefinite.

14. A method, comprising:
accessing data pertaining to a first price for using a first network and a second price for using a second network different from the first network;
receiving user input to join the first network;
joining the first network using subscriber identification module (SIM) data; and
presenting at least one user interface (UI) on a display of a device accessing the SIM data, the UI comprising:
a notice that a price for using a currently connected-to network is about to change, an indication of the currently connected-to network, and an indication of one or more of: a net price change amount along with a time the net price change is effective, and a new price along with a time the new price is effective.

15. The method of claim 14, comprising:
in response to accessing the data, presenting indications of the first price and the second price on a display.

16. The method of claim 14, wherein the data is first data, and wherein the method comprises:
accessing second data pertaining to periods of time from a current time at which the second data is accessed during which the first price and the second price are valid, wherein the periods of time are not indefinite.

17. A method, comprising:
operating a cellular network; and
providing network communication pricing information via at least one user interface (UI) that comprises:
plural virtual subscriber identification module (SIM) data acquisition selectors, each selectable to acquire respective virtual SIM data at respective different times;
plural price selectors, each selectable to acquire a respective price associated with one or more of a respective communication protocol and a pricing protocol; and
plural network selectors, each selectable to acquire communication pricing from a respective network.

18, 19. (canceled)

20. The method of claim 17, wherein the method comprises:
determining the pricing parameter based at least in part on an amount of network activity on
the cellular network during a particular period of time in a particular day.

21. The method of claim 14, wherein the at least one UI further comprises:
a first selector selectable to continue to maintain communicating with the currently connected-to network; and
a second selector selectable to disconnect from the currently connected-to network.

22. The method of claim 14, comprising presenting the at least one UI at a threshold non-zero time before when a price change is identified to occur.

23. The method of claim 17, wherein the plural virtual SIM data acquisition selectors comprise at least two of:
a first selector selectable to acquire the virtual SIM data immediately;
a second selector selectable to acquire the virtual SIM data when a cost is requested for using a network; and
a third selector selectable to acquire the virtual SIM data upon selection of a network.

24. The method of claim 17, wherein the plural price selectors comprise at least two of:
a first selector selectable to acquire price over a telephony network;
a second selector selectable to acquire price over a Wi-Fi network;
a third selector selectable to acquire price using trend data; and
a fourth selector selectable to poll at least one network for pricing.

25. The method of claim 17, wherein at least one network selector comprises:
a first selector selectable to identify a respective network; and
a second selector selectable to one or more of: download a currently available price(s) for use of the respective network, and acquire virtual SIM data for use of the respective network.
